(19) United States
(12) Patent Application Publication
(10) Pub. No.: US 2025/0203202 A1
(43) Pub. Date: Jun. 19, 2025

(54) SYSTEMS AND METHODS FOR CHANGING A CHARACTERISTIC OF A CAMERA LENS

(71) Applicant: Apple Inc., Cupertino, CA (US)

(72) Inventors: Nicholas A. SIMS, Pleasanton, CA (US); Michael D. MCBROOM, Leander, TX (US)

(21) Appl. No.: 18/939,373

(22) Filed: Nov. 6, 2024

Related U.S. Application Data
(60) Provisional application No. 63/611,709, filed on Dec. 18, 2023.

(51) Int. Cl. H04N 23/667

(52) U.S. Cl. CPC H04N 23/667

(57) ABSTRACT

In some embodiments, an electronic device includes a structure defined by a housing or other barriers. This structure optionally includes one or more transparent portions, one or more opaque portions, and/or one or more tintable layers covering one or more components of the electronic device. These layers may switch between operating states responsive to operation of the electronic device.

### CROSS-REFERENCE TO RELATED APPLICATIONS

This application claims the benefit of U.S. Provisional Application No. 63/611,709, filed Dec. 18, 2023, the content of which is incorporated herein by reference in its entirety for all purposes.

### FIELD OF THE DISCLOSURE

Aspects of the present disclosure relate to systems and methods for tinting a camera lens of an electronic device.

### BACKGROUND OF THE DISCLOSURE

An electronic device uses one or more cameras to capture images. The one or more cameras are often integrated with the housing of the electronic device with one or more camera lenses protrude from the housing.

### SUMMARY OF THE DISCLOSURE

In some embodiments, an electronic device includes a structure defined by a housing or other barriers. This structure optionally includes one or more transparent portions, one or more opaque portions, and/or one or more tintable layers. The electronic device also includes one or more cameras, and the one or more cameras or a portion thereof are integrated with this structure. For example, the cameras are positioned to capture images of an external environment of the electronic device. The one or more tintable layers are coupled to the one or more cameras, for example, disposed over one or more lenses of the one or more cameras. The one or more tintable layers optionally have a first tint when not in use. The electronic device optionally receives an input directed towards an application associated with the cameras (e.g., the camera application) that satisfies one or more criteria. In response to receiving the input directed towards the application associated with the cameras, the electronic device optionally transitions the one or more tintable layers from a first tint in a first state to a second, different tint in a second state. In some embodiments, transitions between the first state to the second state enable the one or more tintable layers appear opaque to the human eye, but transparent to the one or more cameras.

### BRIEF DESCRIPTION OF THE DRAWINGS

FIG. 1 illustrates an exemplary hardware block diagram for an electronic device including one or more cameras in accordance with some embodiments of the disclosure.

FIG. 2 illustrates an example mobile telephone in accordance with some embodiments of the disclosure.

FIG. 3A illustrates a side view of an electronic device with one or more cameras and one or more tintable layers in accordance with some embodiments of the disclosure.

FIG. 3B illustrates a close-up view of a camera of an electronic device in accordance with some embodiments of the disclosure.

FIG. 4A-4B illustrates embodiments wherein a tintable layer is in different states in accordance with some embodiments of the disclosure.

FIG. 5 illustrates an embodiment of an electronic device with a plurality of cameras in accordance with some embodiments of the disclosure.

FIG. 6 illustrates an example flowchart of method for transitioning tintable layers in accordance with some embodiments of the disclosure.

### DETAILED DESCRIPTION

In some embodiments, an electronic device includes a structure defined by a housing or other barriers. This structure optionally includes one or more transparent portions, one or more opaque portions, and/or one or more tintable layers. The electronic device also includes one or more cameras, and the one or more cameras or a portion thereof are integrated with this structure. For example, the cameras are positioned to capture images of an external environment of the electronic device. The one or more tintable layers are coupled to the one or more cameras, for example, disposed over one or more lenses of the one or more cameras. The one or more tintable layers are optionally polymer stabilized cholesteric texture (PSCT) layers and/or other electro-chromatic materials. A tintable layer is optionally opaque to the human eye and to a camera (e.g., in a first mode of operation), transparent to the human eye and the camera (e.g., in a second mode of operation), or opaque to the human eye and transparent to a camera (e.g., in a third mode of operation). The tinting behavior applied to the tintable layer (or mode of operation of the tintable layer) is optionally dependent on the activity of the one or more cameras and/or software features of the device (e.g., use of a camera application or other applications that are or are configured toa access a camera). For example, the one or more tintable layers optionally have a first tint (opaque to the human eye and the camera) when the camera is not in use. The electronic device optionally receives an input directed towards an application associated with the cameras (e.g., the camera application) that satisfies one or more criteria. In response to receiving the input directed towards the application associated with the cameras, the electronic device optionally transitions the one or more tintable layers from a first tint in a first state to a second, different tint in a second state. In some embodiments, transitions between the first state to the second state enable the one or more tintable layers appear opaque to the human eye, but transparent to the one or more cameras. In some embodiments, the one or more tintable layers in the second state appear transparent to the human eye and the one or more cameras.

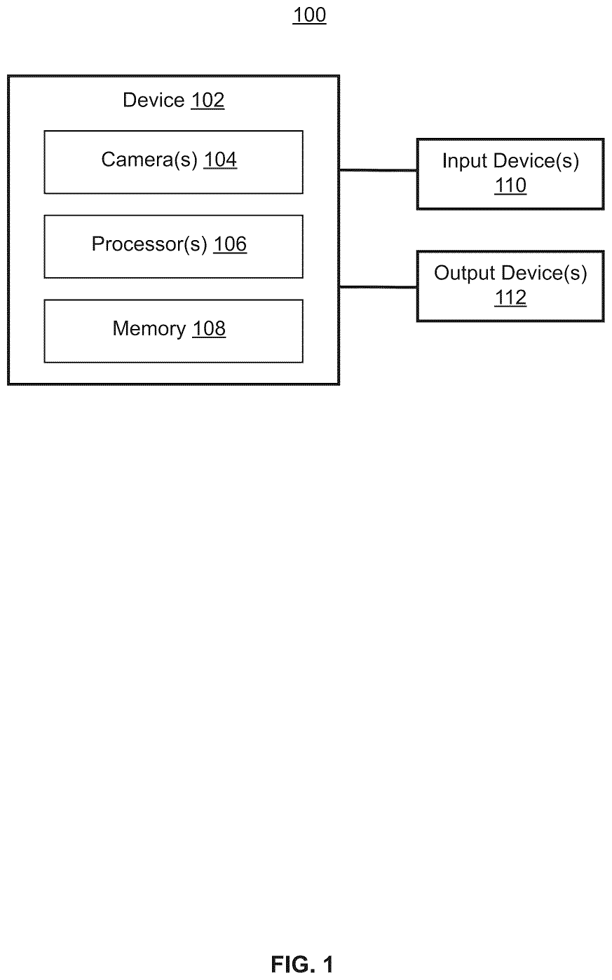

FIG. 1 illustrates an exemplary hardware block diagram 100 for an electronic device including one or more cameras in accordance with some embodiments of the disclosure. Block diagram 100 includes an electronic device 102 which is communicatively coupled to input device(s) 110 (e.g., touch sensor panels, touch screens, trackpads, buttons, joysticks, microphones, cameras, sensors, etc.) and/or output device(s) 112 (e.g., displays, speakers, tactile feedback generators, etc.). In some embodiments, the electronic device 102 is a smart phone, a media player, a tablet computer, a laptop computer, a desktop computer, a wearable device, or any other suitable portable or non-portable electronic device. It is understood that the above electronic devices are examples, but electronic device 102 can be any suitable electronic device providing the functionality described herein.

As shown in FIG. 1, the electronic device 102 includes processor(s) 106, memory 108, and camera(s) 104. In some embodiments, processor(s) 106 includes one or more general purpose processors, one or more graphics processors, one or more digital signal processors (DSPs), microcontrollers, field programmable gate arrays, programmable logic devices, and/or the like configured for performing the operations described herein. Additionally or alternatively, in some embodiments, processor(s) 106 includes one or more of microprocessor(s), application specific integrated circuit(s) (ASIC(s)), central processing unit(s) (CPU(s)), graphics processing unit(s) (GPU(s)), and/or other suitable processing circuitry. Optionally, memory 108 includes a non-transitory computer-readable storage medium (e.g., flash memory, random access memory, or other volatile and/or non-volatile memory or storage) that stores computer-readable instructions or programs configured to be executed by processor(s) 106 to perform the techniques, processes, and/or methods described herein. As used herein, a “non-transitory computer-readable storage medium” includes any tangible medium (e.g., excluding signals) that optionally contains or stores programs/instructions for use by the electronic device (e.g., processing circuitry, processor(s) 106, etc.), for example. The non-transitory computer-readable storage medium optionally includes, but is not limited to, magnetic, optical, and/or semiconductor storage. Examples of such storage include magnetic disks, optical discs based on CD, DVD, or Blu-ray technologies, as well as persistent solid-state memory such as flash, solid-state drives, and the like. Memory 108 optionally includes, but is not limited to, flash memory devices, random access memory (RAM) devices (e.g., dynamic random-access memory (DRAM), static random-access memory (SRAM), double-data-rate random-access memory (DDR RAM), or other high-speed RAM or solid-state RAM, etc.), read-only memory (ROM) devices, or erasable or electrically erasable programmable read-only memory devices (EPROM or EEPROM).

Output device(s) 112 optionally include a display. The display optionally includes a single display (e.g., a liquid-crystal display (LCD), organic light-emitting diode (OLED), or other types of display). Optionally, the display includes multiple displays. In some embodiments, the display includes a display with a touch-sensitive surface (e.g., a touch screen). In some electronic devices, the display optionally includes a projector, a holographic projector, a retinal projector, etc.

Optionally, camera(s) 104 include camera(s) positioned to capture one or more images of the environment outside of the electronic device 102. Camera(s) 104 optionally includes components positioned inside the interior space of the first device and/or components outside of interior space of the electronic device 102. Optionally, the interior space of the electronic device 102 is defined by barriers that include transparent barrier portions (e.g., windows) and opaque barrier portions (e.g., walls, roofs, hulls, and/or body panels). Optionally, one or more components of camera(s) 104 are integrated with the barriers of the electronic device 102. Optionally, the camera(s) 104 includes one or more tintable layers such as polymer stabilized cholesteric texture layers (PSCT layers) or another electro-chromic material stacked on top of the one or more enclosures of the camera(s) 104. The one or more tintable layers are described in further detail below. It is understood that although primarily described as a camera, camera(s) 104 represent any suitable optical sensor or component including one or more light emitters, one or more light detectors, one or more proximity sensors, one or more ranging sensors, one or more depth sensors, etc. Also, although primarily described as a PSCT layer, it is understood that other electrically tintable lenses are optionally used in place of a polymer stabilized cholesteric texture layer such as other electro-chromatic materials.

Memory 108 and processor(s) 106 of the electronic device 102 are optionally in communication with each other and camera(s) 104. For example, memory 108 stores instructions that, when executed by processor(s) 106, cause the electronic device 102 to capture one or more image(s) using camera(s) 104.

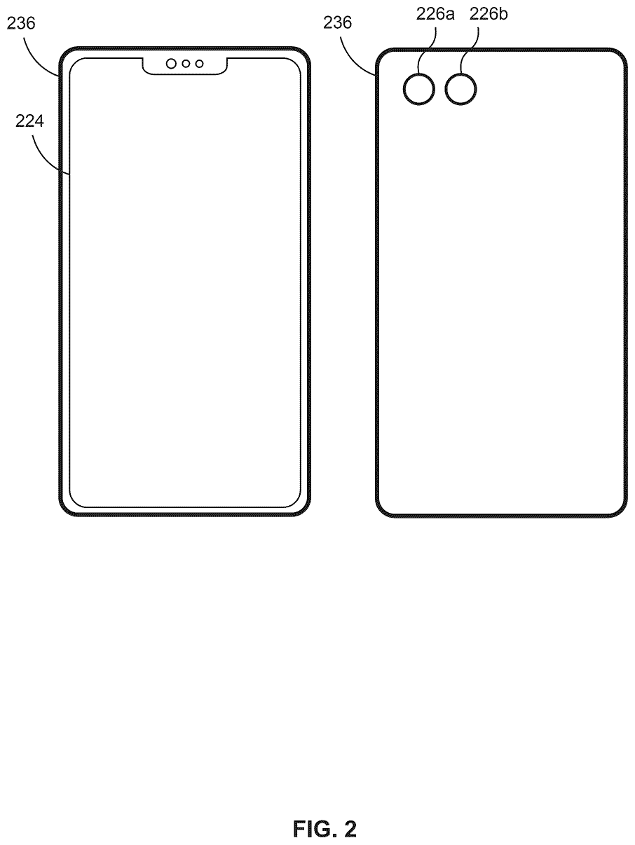

FIG. 2 illustrates an example mobile telephone 136 that includes a touch screen 124 and cameras 226a and 226b that includes one or more tintable layers which optionally change tint levels (e.g., tint, untint) over the cameras based on one or more criteria according to embodiments of the disclosure. The device is optionally a laptop, tablet, multimedia device, or other device that includes one or more cameras. Optionally, the display including touch screen 124 and the cameras 226a and 226b are integrated into the housing of the mobile telephone 136. For example, the cameras 226a and 226b protrude from or are located in and/or on the housing on the side of the device opposite the touch screen 124. The touch screen 124 is optionally located at the front side of the mobile telephone 136 and the cameras 226a and 226b are located at the back of the mobile telephone 136. Optionally, the mobile telephone 136 includes additional cameras (not shown) on the same side of the device as touch screen 124 (e.g., front facing cameras). It is understood that the placement of the cameras 226a and 226b are illustrative, but not limiting to the placement and/or number of cameras including in mobile telephone 136.

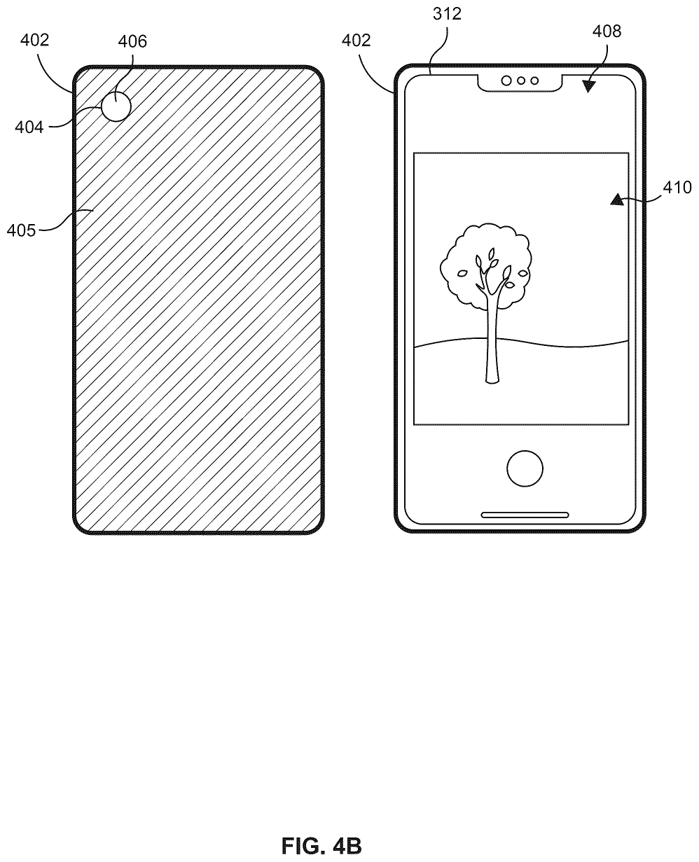

One or more tintable layers are coupled to (e.g., located on top of a camera lens of the camera) the camera 226a and 226b. Additionally or alternatively, a tintable layer is coupled to a front facing camera. The one or more tintable layers are configured to change the transparency of the layer by tinting or untinting the one or more tintable layers. In some embodiments, untinting the one or more tintable layers enables the camera to capture images through the one or more tintable layers, and tinting the one or more tintable layers enables hiding the cameras from the human eye. For example, the one or more tintable layers is tinted such that light is not able to enter through the camera enclosure to the camera lens. As a result of the tinting of the tintable layer, the camera is not visible to the human eye (e.g., the tinting of the tintable layer blends in with the visual characteristics of the other portions of the electronic device, as described in FIGS. 4A-4B. While the tintable layer is untinted such that light is able to enter through the camera enclosure to the camera lens when capturing images, the camera is visible to the human eye. In some examples, the camera is not visible when the tintable layer is pulsed between the untinted state and the tinted state, as described below. In some embodiments, tinting or untinting the one or more tintable layers is optionally used to change the visual appearance of the cameras (e.g., to show the camera when performing capturing functions and to hide the camera when not). This allows the user to visually see when the camera(s) are actively on.

Additionally, in some embodiments, the appearance of tinting of the one or more tintable layers optionally matches the visual appearance of the back of the housing of mobile telephone 136, such that when the tintable layers are tinted, the tintable layers over the cameras 226a and 226b and the housing have the same visual appearance (e.g., the device appears to have a uniform appearance for the opaque regions of the housing and the regions with the tintable layers. Additionally, when the tintable layers are untinted, the tintable layers over the cameras 226a and 226b no longer have the same visual appearance as the back of the housing, which allows light to reach the camera lens and/or allows the cameras to be visible to a human, and therefore allowing a user or other person to determine that the cameras 226a and 226b are active.

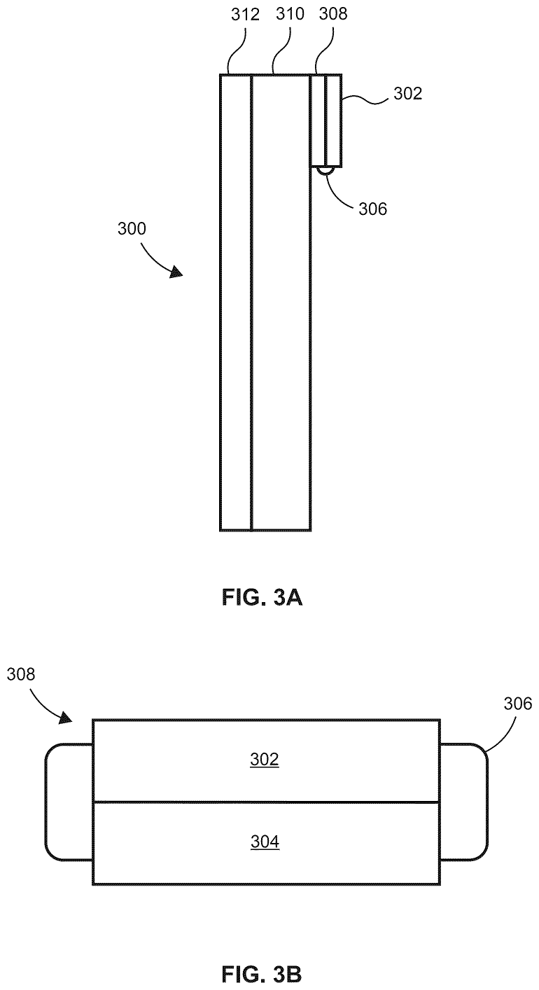

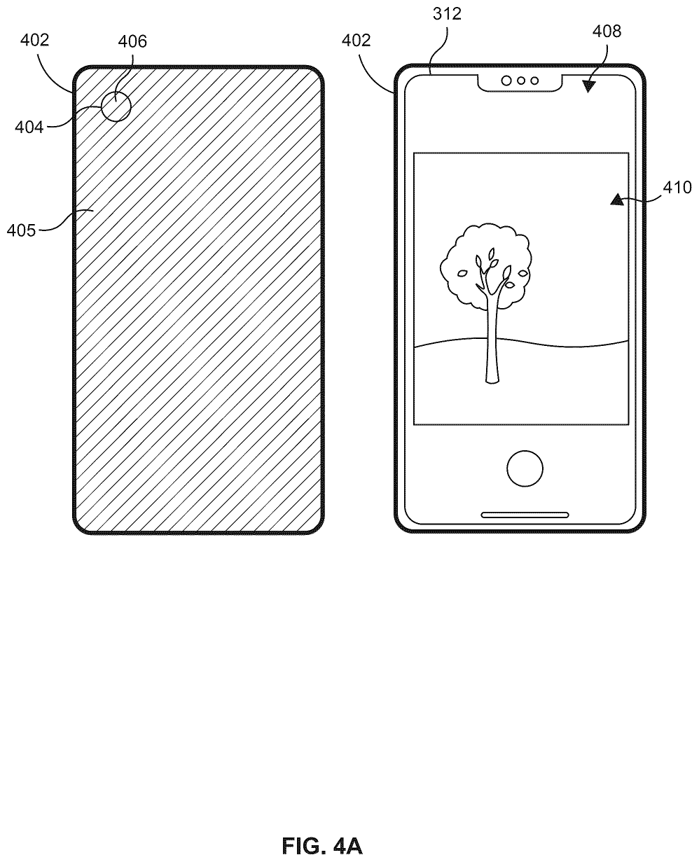

FIG. 3A illustrates a side view of an electronic device 300 with one or more cameras and one or more tintable layers according to some embodiments of the disclosure. FIG. 3B illustrates a close-up view of a camera 308 of electronic device 300 where the tintable layer 302 is coupled to camera lens 304 according to some embodiments of the disclosure. The electronic device 300 optionally has one or more characteristics of the devices as described above, the details of which are not repeated here for brevity. The electronic device 300 optionally includes a touch screen 312, which has one or more characteristics of the touch screen 124 as described in FIG. 1. Touch screen 312 proves an input interface and an output interface between the electronic device 300 and a user, such as by sensing touch inputs and displaying images. In some embodiments, the touch-sensitive operation and the display operation of the touch screen 312 are optionally separated from each other, such that a display device is used for display purposes and the described components and functions are modified accordingly. However, for simplicity, the following description is provided with reference to a touch screen. Touch screen 312 optionally uses LCD (liquid crystal display) technology, LPD (light emitting polymer display) technology, or LED (light emitting diode) technology, although other display technologies are used in other embodiments. Touch screen 312 and display controller 156 optionally detect contact and/or proximate hovering objects and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 312.

As shown in FIG. 3A, electronic device 300 also includes housing 310. At least a portion of the housing 310 is located behind the touch screen 312 (and/or around touch screen 312). The housing 310 of the electronic device 300 holds mechanical and electronical components of the electronic device 300, such as one or more of the components described above with reference to FIG. 1. The housing 310 optionally holds sensors, controllers, circuitry, to manage operations on the electronic device 300. For example, the housing 310 optionally holds portions and/or components of optical sensors, contact intensity sensors, proximity sensors, accelerometers, or other sensors. The housing 310 also optionally holds tactile output generators, a power system (e.g., power sources, power management system, recharging system, and other components associated with the generation, management, and distribution of power in portable or non-portable electronic devices), audio circuitry, memory components, and other components to be used for operations on the electronic device 300. Some of the aforementioned components are optionally partially integrated with the housing (e.g., not simply housed within the housing).

Electronic device 300 also includes camera 308. Camera 308 has one or more characteristics of the cameras as described herein. In some embodiments, camera 308 is located opposite the touch screen 312 relative to the housing 310. For example, camera 308 is located on the back surface of the electronic device 300 while touch screen 312 is located at the front surface of the electronic device 300. In some examples, camera 308 includes one or more optical sensors, one or more lenses, and other imagery equipment located within a camera enclosure. As described above, camera 308 is used to capture imagery of a physical environment external to the electronic device 300. As shown in FIG. 3B, the camera 308 includes a camera lens 304.

Optionally, a tintable layer 302 is coupled to the camera 308. In some embodiments, the tintable layer 302 is a liquid crystal layer that appears opaque to the human eye when an electrical stimulation has not been applied, such as a PSCT layer or other electro-chromatic materials. In some embodiments, as a result of electrical stimulation (e.g., by circuitry 306, shown in FIGS. 3A and 3B), the tintable layer 302 becomes transparent such that light reaches the camera lens. Alternatively, in some embodiments, the tinting layer is transparent without electrical stimulation, and when the electrical stimulation is applied, the tinting layer becomes opaque. In some embodiments, a characteristic of the electrical stimulation enables tinting between maximum and minimum states (e.g., between opaque and transparent). As shown in FIG. 3A, a tintable layer 302 is stacked on top of camera 308. Specifically, in some embodiments, the tintable layer 302 is stacked on top of the camera 308 or an enclosure thereof at the position shown in FIG. 3A. Alternatively, in some embodiments, the tintable layer 302 is the outermost layer within the camera enclosure. Optionally, the tintable layer 302 is located above the camera lens 304 (e.g., the camera lens is between the camera lens 204 and the housing 310 of the electronic device 300, as shown in FIG. 3B. Optionally, the tintable layer 302 lies flush with the housing of electronic device 300 above the camera 308. For example, the tintable layer 302 is optionally curved on one side to conform to the curved shape of the camera lens and/or the camera enclosure. Optionally, circuitry 306 is housed partially or fully within the electronic device 300. For example, circuitry 306 connecting the tintable layer 302 to the power supply of the electronic device 300 is optionally located within housing 310. Optionally, and as described in further detail below, the electronic device 300 provides instruction to circuitry 306 to apply electrical stimulation to the tintable layer 302. As a result of the electrical stimulation, the tintable layer 302 transitions from a first state (e.g., corresponding to an opaque tint) to a second state (e.g., transparent state with little or no tint). In some embodiments, the electronic device 300 pulses the electrical stimulation such that the tintable layer 302 rapidly transitions between the first state to the second state. Pulsing the tintable layer between the first state and the second state (e.g., between the first tint and the second tint) at a high enough frame rate results in the tintable layer appearing in the first state to the human eye and appears in the second state (e.g., with the second tint, or transparent) to the camera. Optionally, the electronic device is configured to operate with the tintable layer in the first state, in the second state, or rapidly transitioning between the first and second states depending on the operating conditions, which are optionally differentiated using different criteria.

FIG. 4A illustrates an embodiment wherein a tintable layer is in a first state or a primarily in the first state (rapidly transitioning between the first state and the second state so as to appear opaque to a human eye in accordance with some embodiments of the disclosure. FIG. 4A illustrates an electronic device 402 with touch screen 312 displaying a camera user interface 408 of a camera application. The electronic device 402 optionally has one or more characteristics of the devices as described herein. Electronic device 402 optionally includes a camera 404 that has one or more characteristics of the cameras as described herein. As shown in FIG. 4A, camera 404 is located on the back side of electronic device 402, opposite from touch screen 312. For example, the camera 404 optionally protrudes from the housing of the electronic device. The housing at the back side of electronic device 402 includes a first visual characteristic represented by the shading pattern in FIG. 4A. For example, first visual characteristic includes a certain color, material, material finish, or a combination of characteristics. In some embodiments, tintable layer 406 is on top of camera 404 (e.g., covering camera 404). The tintable layer 406 is optionally an external layer outside of the housing and/or flush with the device housing. In some embodiments, the tintable layer also includes the first visual characteristic represented by the shading pattern in FIG. 4A while in the first state (or when rapidly transitioning between the first and second states such that the tintable layer appears to be in the first state to the human eye), such that the back of device 402 has an uninterrupted (contiguous and/or uniform) cosmetic look of the visual characteristic represented by the shading pattern in FIG. 4A. In some embodiments, the device 402 pulses (e.g., via the circuitry as described in FIGS. 2 and 3) the tintable layer 406 between the first state and the second state (e.g., between the first tint and the second tint) such that the tintable layer 406 appears with the first tint and with first visual characteristic represented by the shading pattern in FIG. 4A to the human eye and appears transparent to camera 404. For example, the tintable layer 406 optionally pulses at a frame rate (e.g., 1 frames per second (fps), 5 fps, 8 fps, 12 fps, or 20 fps) such that the tintable layer appears to be in the first state to the human eye even though the tintable layer is in the second state at times. The pulsing of the tintable layer 406 aligns with the timing of repeated image capture by the camera. For example, while the camera captures an image, the tintable layer 406 is in the second state; and between image captures, the tintable layer is in the first state. Specifically, during the pulsing, the tintable layer 406 is in the second state for a time window (e.g., 502 us, 520 us, 700 us, 3 ms, 7 ms, 11 ms, etc.) greater than an exposure duration (e.g., 501 us, 510 us, 600 us, 2 ms, 6 ms, 11 ms, etc.) of the camera. For example, the camera may capture images at a frame rate (e.g. 1 fps, 5 fps, 8 fps, 12 fps, or 20 fps) that has an exposure window (e.g., 500 us, 1 ms, 5 ms, 10 ms, etc.) less than the exposure duration. As such, the tintable layer 406 is in the second state long enough for the camera to capture an image before transitioning back to the first state. In some embodiments, the tintable layer is transitioned to the second state in advance of the image capture by a first buffer period (e.g., 1 ms, 5 ms, 10 ms, etc.) and/or remains in the second state after the image capture for a second buffer period (e.g., 500 us, 1 ms, 5 ms, etc.).

In some embodiments, the tintable layer 406 is in the first state while the camera 404 is not actively in use (e.g., before the electronic device 402 receives any inputs to open an application associated with camera 404). In some embodiments, the tintable layer 406 rapidly transitions between the first and second states while the camera 404 is in use. For example, as shown in FIG. 4A, the tintable layer 406 appears to have the first tint and the first visual characteristic represented by the shading pattern in FIG. 4A while the camera user interface 408 of the camera application is open. Because the tintable layer 406 is rapidly transitioning between the first and second states, the electronic device 402 is able to display a representation of the physical environment 410 captured by the camera on the camera user interface 408 because the camera 404 is able to see through the tintable layer 406. Alternatively, in some embodiments, the device 402 transitions the tintable layer 406 from the first state to the second state in response to detecting an input that satisfies one or more criteria. For example, the input that satisfies one or more criteria may correspond to a request to open the camera application, or other applications that includes the operation of the camera, such as a social media application that allows the user to capture images to share on social media, a notes application that allows the user to capture images to include in notes, or an online store (in an online store app or a web browser) that uses the camera for scanning credit card information. Additionally, or alternatively, the input may correspond to a hardware or software button input, such as an input directed towards a record button or a photo taking button on the electronic device 402. The input that satisfies the one or more criteria may optionally depend on the currently active camera. For example, the input that satisfies the one or more criteria for a front facing camera is optionally different than the input that satisfies the one or more criteria for a back facing camera. The tintable layers can transitioned into the second state when these applications are launched, when displaying a UI including a camera function option, and/or when the camera functions are initiated. For example, while displaying the camera user interface 408 including the representation of the physical environment 410, the tintable layer 406 is in the second state, as shown in FIG. 4B. While in the second state, the tintable layer 406 has a second tint and a second visual characteristic different than first visual characteristic (the pattern of shading of FIG. 4A appears for the housing, but not for the tintable layer 406). The electronic device 402 optionally transitions the tintable layer 406 from the first state to the second state and keeps the tintable layer 406 in the second state to indicate to the user that the camera is active (and to have the camera actually be visible through the tintable layer and to allow light to pass through the tintable layer 406 to the camera 404.

In some embodiments, the electronic device 402 transitions the tintable layer 406 to the first state after detecting that the camera 404 is no longer active. For example, in response to detecting that the camera application is no longer running (e.g., the camera user interface 408 is no longer displayed and a home screen or other user interface is displayed instead), or in response to detecting that the user interface no longer needs access to the camera (e.g., photo review user interface of the camera application), the electronic device 402 transitions the tintable layer 406 from the second state to the first state by no longer providing electrical stimulation to the tintable layer 406 (or stops rapidly transitioning between the first state and the second state). After transitioning to the first state, the tintable layer 406 optionally appears with the first tint and the first visual characteristic as described above.

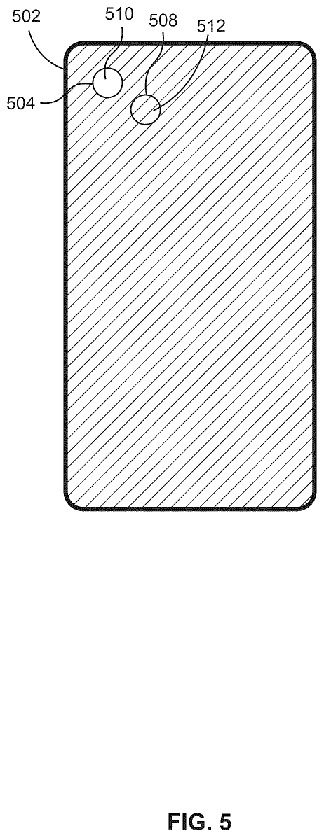

FIG. 5 illustrates an embodiment of an electronic device with a plurality of cameras in accordance with some embodiments of the disclosure. Electronic device 502 is optionally of the same or similar architecture as other devices described herein, such as including a housing with a touch screen on one side and a camera on the other. In FIG. 5, electronic device 502 includes cameras 504 and 508, which are found on the backside of electronic device 502 relative to the display of the device (not shown in FIG. 5). In some embodiments, each camera includes an independently tintable tintable layer. For example, camera 504 includes tintable layer 510 and camera 508 includes tintable layer 512. In some embodiments, the electronic device 502 provides electrical stimulation to one or both of the tintable layers at a time. For example, and as shown in FIG. 5, electronic device 502 provides electrical stimulation to tintable layer 510 without applying electrical stimulation to tintable layer 512, which causes tintable layer 510 to be in the second state, while tintable layer 512 is in the first state. In some embodiments, the electronic device 502 operates the tintable layer on the camera that is currently active in the second state (or rapidly transitions between the first and second states). For example, while operating the camera application of the electronic device 502, a user can choose which camera to use (e.g., the ultra-wide camera, the telephoto camera, or the standard camera), and in response to determining which camera to use, the electronic device 502 provides electrical stimulation to tintable layer associated with the specified camera. Alternatively, in some embodiments, the tintable layers (or tintable layer) are stimulated concurrently, so regardless of the camera in use, the electronic device 502 operates tintable layers associated with multiple cameras in the second state (or rapidly transitioning between the first and second states). Alternatively, in some embodiments, multiple cameras share the same tintable layer. As a result, when the electronic device 502 stimulates the tintable layer, multiple cameras are in the second state (or rapidly transitioning between the first and second states). Additionally or alternatively, in some embodiments, the electronic device 502 operates some tintable layers associated with certain cameras in the second state while operating other tintable layers associated with other cameras by rapidly transitioning between the first and second states. For example, the electronic device 502 may operate the tintable layer associated with a front facing camera using the second state and the tintable layer associated with a back facing camera by rapidly transitioning between the first and second states. Additionally or alternatively, some camera lenses with a slower aperture rate, and the electronic device 502 optionally operates the tintable layers associated with those cameras in the second state while capturing photos/videos (or transitions between the first and second states at a different frame rate).

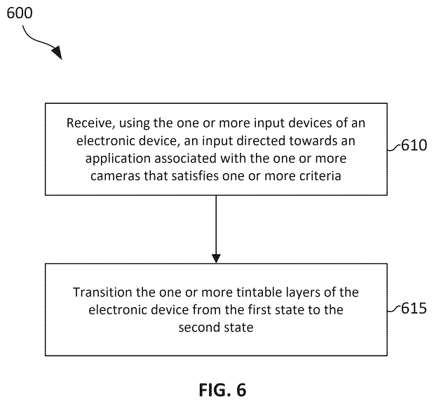

FIG. 6 is an example flowchart of method 600 for transitioning tintable layers according to some embodiments of the disclosure. An electronic device (e.g., electronic devices 236, 300, 402, and/or 502) includes one or more tintable layers (e.g., tintable layer 302, 406, 510, and/or 512) coupled to one or more cameras (e.g., camera 308, 404, 504, and/or 508). In some embodiments, the tintable layer includes a first tint when the one or more cameras are inactive, such as before the electronic device receives an input directed towards an application associated with the one or more cameras. For example, the first tint prevents the camera lenses of the camera(s) from receiving light or reduces the amount of light received from the external environment (e.g., opaque tint) and/or reduces or block visibility of the one or more cameras by a human. Additionally, and optionally, the first tint has a visual characteristic that matches or is similar to the visual characteristic of the housing of the back of the electronic device. In some embodiments, the one or more cameras are located on a side of the electronic device opposing a side of the electronic device including a display, or on a different side not including a display. Alternatively, in some embodiments, the one or more cameras are located on of the same side of the electronic device as a display.

The electronic device receives, using the one or more input devices (e.g., touch screen 312), an input directed towards an application associated with the one or more cameras that satisfies one or more criteria at block 610. In some embodiments, the one or more criteria includes a criterion that is satisfied when the input (e.g., using an input device or user interface element) is directed towards activating the camera. For example, the input is directed towards opening a camera application, taking a picture with the camera application or another application, and/or taking a video with the camera application or another application. In some embodiments, the camera application includes a photo/video taking application, a video calling application, or other applications requiring the use of cameras. In response to receiving the input directed towards the application associated with the one or more cameras, the electronic device transitions the one or more tintable layers from the first state to the second state at block 615. In some embodiments, in response to receiving the input, the electronic device transitions the tintable layers between the first state and the second state. While in the second state (or rapidly transitioning between the first and second states), the one or more cameras are able to receive light from the physical environment to take a photo or a video. After capturing the photo and/or video and/or after the one or more cameras are deactivated, the one or more tintable layer over the one or more cameras return back to the first state.

In the present disclosure, the methods disclosed are optionally implemented as sets of instructions or software readable by a device. Further, it is understood that the specific order or hierarchy of steps in the methods disclosed are instances of example approaches. Based upon design preferences, it is understood that the specific order or hierarchy of operations in the method can be rearranged while remaining within the disclosed subject matter. The accompanying method claims present elements of the various operations in a sample order and are not necessarily meant to be limited to the specific order or hierarchy presented. The described disclosure is optionally provided as a computer program product, or software, that optionally includes a non-transitory machine-readable medium having stored thereon instructions, which is optionally used to program a computer system (or other electronic devices) to perform a process according to the present disclosure. A machine-readable medium includes any mechanism for storing information in a form (e.g., software, processing application) readable by a machine (e.g., a computer).

Technology implementors are reminded that capturing and/or storing of image data (e.g., camera images) should be performed in accordance with privacy practice(s) meeting or exceeding local laws and/or industry privacy practices and standards. These privacy practices optionally include, but are not limited to, providing an indication that a camera is active such as by including a camera status indicator (e.g., a light emitting diode indicating that a camera is active), providing audio feedback of camera capture, and/or by allowing the camera to be visible through a tintable layer. While a tintable layer may provide for an aesthetically pleasing and/or innovative industrial designs, implementors are reminded that these design considerations should be balanced with privacy considerations, such as by clearly indicating via a user interface or other communication element during active use of the camera or otherwise as appropriate.

According to the above, embodiments are directed to a method comprising at an electronic device in communication with one or more cameras, one or more input devices, and one or more tintable layers coupled to the one or more cameras, wherein the one or more tintable layers includes a first tint in a first state and a second tint in a second state that is more transparent than the first tint: receiving, using the one or more input devices, an input directed towards an application associated with the one or more cameras that satisfies one or more criteria; and in response to receiving the input directed towards the application associated with the one or more cameras, transitioning the one or more tintable layers from the first state to the second state. Additionally or alternatively to one of more of the embodiments disclosed above, in some embodiments, the method further comprises covering one or more outer enclosures of the one or more cameras with the one or more tintable layers. Additionally or alternatively to one of more of the embodiments disclosed above, in some embodiments, the one or more tintable layers includes a curved surface. Additionally or alternatively to one of more of the embodiments disclosed above, in some embodiments, the method further comprises coupling a tintable layer of the one or more tintable layers to a plurality of the one or more cameras. Additionally or alternatively to one of more of the embodiments disclosed above, in some embodiments, the method further comprises coupling a first tintable layer of the one or more tintable layers to a first camera of the one or more cameras, and coupling a second tintable layer of the one or more tintable layers to a second camera of the one or more cameras. Additionally or alternatively to one of more of the embodiments disclosed above, in some embodiments, the method further comprises in response to receiving a first input that satisfies the one or more criteria, transitioning the first tintable layer coupled to the first camera without transitioning the second tintable layer coupled to the second camera; and in response to receiving a second input that satisfies the one or more criteria, transitioning the second tintable layer coupled to the second camera without transitioning the first tintable layer coupled to the first camera. Additionally or alternatively to one of more of the embodiments disclosed above, in some embodiments, the one or more cameras are surrounded by a surface having a first visual characteristic and the one or more tintable layers in the first state with the first tint also have the first visual characteristic. Additionally or alternatively to one of more of the embodiments disclosed above, in some embodiments, prior to receiving the input, the one or more tintable layers are in the first state with the first tint. Additionally or alternatively to one of more of the embodiments disclosed above, in some embodiments, the method further comprises operating the one or more tintable layers in the first state while the electronic device operates in a first mode, and the input that satisfies the one or more criteria corresponds to transition of the electronic device from operating in the first mode to operating in a second mode different from the first mode. Additionally or alternatively to one of more of the embodiments disclosed above, in some embodiments, the method further comprises operating the one or more tintable layers in the second state while the electronic device is in the second mode. Additionally or alternatively to one of more of the embodiments disclosed above, in some embodiments, the method further comprises while in the second mode, repeatedly transitioning the one or more tintable layers between the first state and the second state at a frame rate above a frame rate threshold. Additionally or alternatively to one of more of the embodiments disclosed above, in some embodiments, the method further comprises in accordance with a determination that one or more second criteria are satisfied while operating in the second mode, transitioning from the second state back to the first state. Additionally or alternatively to one of more of the embodiments disclosed above, in some embodiments, the one or more input devices includes a touch screen and the one or more cameras are located opposite from the touch screen. Additionally or alternatively to one of more of the embodiments disclosed above, in some embodiments, the method further comprises applying electrical stimulation to the one or more tintable layers using circuitry to transition the one or more tintable layers.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

While some embodiments of the disclosure are described herein, additional and alternative embodiments are possible. Example embodiments are provided in the drawings and detailed description and are illustrative in nature. Modifications to the example embodiments are possible without departing from the scope of the disclosure.

1. An electronic device comprising:
one or more cameras;
one or more tintable layers coupled to the one or more cameras, wherein the one or more tintable layers includes a first tint in a first state and a second tint in a second state that is more transparent than the first tint;
one or more input devices;
a memory; and
one or more processors coupled to the one or more cameras, the one or more input devices, and the memory, the one or more processors configured to:
receive, using the one or more input devices, an input directed towards an application associated with the one or more cameras that satisfies one or more criteria; and
in response to receiving the input directed towards the application associated with the one or more cameras, transition the one or more tintable layers from the first state to the second state.

2. The electronic device of claim 1, wherein the one or more tintable layers is covering one or more outer portions of the one or more cameras.

3. The electronic device of claim 1, wherein the one or more tintable layers includes a curved surface.

4. The electronic device of claim 1, wherein a tintable layer of the one or more tintable layers is coupled to a plurality of the one or more cameras.

5. The electronic device of claim 1, wherein a first tintable layer of the one or more tintable layers is coupled to a first camera of the one or more cameras, and a second tintable layer of the one or more tintable layers is coupled to a second camera of the one or more cameras.

6. The electronic device of claim 5, wherein the one or more processors are configured to:
in response to receiving a first input that satisfies one or more criteria, transition the first tintable layer coupled to the first camera without transitioning the second tintable layer coupled to the second camera; and
in response to receiving a second input that satisfies one or more criteria, transition the second tintable layer coupled to the second camera without transitioning the first tintable layer coupled to the first camera.

7. The electronic device of claim 1, wherein the one or more cameras are surrounded by a surface having a first visual characteristic and the one or more tintable layers in the first state with the first tint also have the first visual characteristic.

8. The electronic device of claim 1, wherein prior to receiving the input, the one or more tintable layers are in the first state with the first tint.

9. The electronic device of claim 1, wherein the one or more processors are configured to operate the one or more tintable layers in the first state while the electronic device operates in a first mode, and the input that satisfies the one or more criteria corresponds to transition of the electronic device from operating in the first mode to operating in a second mode different from the first mode.

10. The electronic device of claim 9, wherein the one or more processors are further configured to:
while in the second mode, operate the one or more tintable layers in the second state.

11. The electronic device of claim 9, wherein the one or more processors are further configured to:
while in the second mode, repeatedly transition the one or more tintable layers between the first state and the second state such that the one or more tintable layers are in the second state for a time window greater than an exposure duration.

12. The electronic device of claim 11, wherein a camera of the one or more cameras covered by the one or more tintable layers operates at a frame rate having an exposure window less than the exposure duration.

13. The electronic device of claim 9, wherein the one or more processors are further configured to:
in accordance with a determination that one or more second criteria are satisfied while operating in the second mode, transition from the second state back to the first state.

14. The electronic device of claim 1, wherein the one or more input devices includes a touch screen and the one or more cameras are located opposite from the touch screen.

15. The electronic device of claim 1, further comprising:
circuitry configured to apply electrical stimulation to the one or more tintable layers, wherein the one or more processors transitioning the one or more tintable layers includes applying, using the circuitry, electrical stimulation to the one or more tintable layers.

16. A method comprising:
at an electronic device in communication with one or more cameras, one or more input devices, and one or more tintable layers coupled to the one or more cameras, wherein the one or more tintable layers includes a first tint in a first state and a second tint in a second state that is more transparent than the first tint:
receiving, using the one or more input devices, an input directed towards an application associated with the one or more cameras that satisfies one or more criteria; and
in response to receiving the input directed towards the application associated with the one or more cameras, transitioning the one or more tintable layers from the first state to the second state.

17. The method of claim 16, further comprising operating the one or more tintable layers in the first state while the electronic device operates in a first mode, and the input that satisfies the one or more criteria corresponds to transition of the electronic device from operating in the first mode to operating in a second mode different from the first mode.

18. A non-transitory computer readable storage medium storing one or more programs, the one or more programs comprising instructions, which when executed by one or more processors of an electronic device in communication with one or more cameras, one or more input devices, and one or more tintable layers coupled to the one or more cameras, wherein the one or more tintable layers includes a first tint in a first state and a second tint in a second state that is more transparent than the first tint, cause the electronic device to perform a method comprising:
receiving, using one or more input devices of the electronic device, an input directed towards an application associated with one or more cameras that satisfies one or more criteria; and
in response to receiving the input directed towards the application associated with one or more cameras of the electronic device, transitioning one or more tintable layers of the electronic device from the first state to the second state.

19. The non-transitory computer readable storage medium of claim 16, the method further comprising coupling a first tintable layer of the one or more tintable layers to a first camera of the one or more cameras, and coupling a second tintable layer of the one or more tintable layers to a second camera of the one or more cameras.

20. The non-transitory computer readable storage medium of claim 16, the method further comprising operating the one or more tintable layers in the first state while the electronic device operates in a first mode, and the input that satisfies the one or more criteria corresponds to transition of the electronic device from operating in the first mode to operating in a second mode different from the first mode.
